(19) United States
(12) Patent Application Publication
(10) Pub. No.: US 2025/0019584 A1
(43) Pub. Date: Jan. 16, 2025

(54) GRAPHENE-BASED NANOCOOLANT WITH HIGH THERMAL CONDUCTIVITY AND THERMAL PERFORMANCE

(71) Applicant: Ford Global Technologies, LLC, Dearborn, MI (US)

(72) Inventors: Rodrigo Denizarte de Oliveira Polkowski, Salvador (BR); Ricardo Albuquerque, Salvador (BR); Julio Okada, Salvador (BR); Gilles Margaria, Lauro de Freitas (BR); Giordano Flores, Esteio (BR); Wilson Caldeira Filho, Franciscópolis (BR); Antonio Henrique Almeida, Salvador (BR); Adilson Canovas Almeida, Lauro de Freitas/Buraquinho (BR)

(73) Assignee: Ford Global Technologies, LLC, Dearborn, MI (US)

(21) Appl. No.: 18/352,694

(22) Filed: Jul. 14, 2023

(51) Int. Cl. C09K 5/14

(52) U.S. Cl. CPC C09K 5/14

(57) ABSTRACT

A nanocoolant fluid includes water, a coolant, a surfactant, and hybrid nanoparticles. The hybrid nanoparticles include a first type of nanoparticles and a second type of nanoparticles. The first type of nanoparticles is thermally conductive and hydrophobic. The second type of nanoparticles is hydrophilic.

### FIELD

The present disclosure relates to coolant fluids, and more specifically to nanocoolants.

### BACKGROUND

The statements in this section merely provide background information related to the present disclosure and may not constitute prior art.

A typical coolant for a vehicle cooling system consists of a mixture between a coolant such as ethylene glycol and water. Ethylene glycol is a component that brings important antifreeze properties to the system and thus helps to control the temperature of the engine (˜−40-120° C.) in an internal combustion car or battery pack and electronic devices (e.g., ISC, OBG, etc.) (˜−40-70° C.) in an electric car. However, ethylene glycol is not very effective as a heat transfer fluid because of its poor thermal conductivity. Thus, the thermal efficiency of ethylene glycol is limited. By enhancing the thermal efficiency of a coolant by increasing its thermal conductivity, the size of the cooling system could be reduced.

The present disclosure addresses these challenges related to thermal efficiency, among other issues related to the cooling of various components of motor vehicles.

### SUMMARY

This section provides a general summary of the disclosure and is not a comprehensive disclosure of its full scope or all of its features.

In one form, the present disclosure provides a nanocoolant fluid including water, a coolant, a surfactant, and hybrid nanoparticles. The hybrid nanoparticles include a first type of nanoparticles and a second type of nanoparticles. The first type of nanoparticles is thermally conductive and hydrophobic. The second type of nanoparticles is hydrophilic.

In variations of this form, which may be implemented individually or in any combination: the first type of nanoparticles of nanoparticles is graphene nanoplatelets, the second type of nanoparticles comprises graphene oxide nanoparticles; the second type of nanoparticles comprises cellulose nanocrystals; the volumetric ratio of the first type of nanoparticles to the second type of nanoparticles is 1:1; the volumetric percent of the hybrid nanoparticles is between 0.01% and 0.5%; the coolant is ethylene glycol and the volumetric ratio of coolant to water is 40:60 or less; and the surfactant is sodium dodecylbenzene sulfonate and the volumetric percent of the surfactant is between 0.05% and 0.35%.

The present disclosure further provides a nanocoolant fluid including water, ethylene glycol, a surfactant, and hybrid nanoparticles. The hybrid nanoparticles include a first type of nanoparticles and a second type of nanoparticles. The first type of nanoparticles is graphene nanoplatelets. The second type of nanoparticles is selected from the group of graphene oxide nanoparticles and cellulose nanocrystals.

In variations of this form, which may be implemented individually or in any combination: the volumetric ratio of the first type of nanoparticles to the second type of nanoparticles is 1:1; the volumetric percent of the hybrid nanoparticles is between 0.01% and 0.5%; the volumetric ratio of ethylene glycol to water is 40:60 or less; and the surfactant is sodium dodecylbenzene sulfonate and the volumetric percent of the surfactant is between 0.05% and 0.35%.

In yet another form, the present disclosure also provides a nanocoolant fluid including deionized water, ethylene glycol, a sodium dodecylbenzene sulfonate, and hybrid nanoparticles. The hybrid nanoparticles include a first type of nanoparticles and a second type of nanoparticles. The first type of nanoparticles is graphene nanoplatelets. The second type of nanoparticles is hydrophilic.

In variations of this form, which may be implemented individually or in any combination: the second type of nanoparticles comprises graphene oxide nanoparticles; the second type of nanoparticles comprises cellulose nanocrystals; the volumetric ratio of the first type of nanoparticles to the second type of nanoparticles is 1:1; the volumetric percent of the hybrid nanoparticles is between 0.01% and 0.5%; the volumetric ratio of coolant to water is 40:60 or less; and the volumetric percent of the sodium dodecylbenzene sulfonate is between 0.05% and 0.35%.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawing, in which:

FIG. 1 is a flowchart illustrating a method for producing a nanocoolant fluid in accordance with the principles of the present disclosure.

The drawing described herein is for illustration purposes only and is not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A nanocoolant is a coolant mixed with nanoparticles and one of its most promising applications is in thermal management systems. The present disclosure provides a novel nanocoolant fluid that includes water, a coolant, a surfactant, and hybrid nanoparticles. The hybrid nanoparticles are a combination of nanoparticles, which include a first type of nanoparticles that are thermally conductive and hydrophobic, and a second type of nanoparticles that are hydrophilic.

In one form of the present disclosure, the volumetric ratio of coolant to water of the nanocoolant fluid is 40:60 or less. In some of these forms, the ratio is 30:70 or 20:80, although other ratios may be used while remaining within the scope of the present disclosure. In one form, the water is deionized water. In one form, the coolant is ethylene glycol. Ethylene glycol provides anti-freeze properties to the nanocoolant fluid but has poor thermal conductivity. The limited thermal conductivity of the ethylene glycol is balanced by the addition of the hybrid nanoparticles.

The hybrid nanoparticles include a first type of nanoparticles and a second type of nanoparticles. The first type of nanoparticles is thermally conductive and increases the thermal performance of the nanocoolant fluid. However, nanofluids are prone to instability resulting in particle agglomeration and/or precipitation. In order to help stabilize the suspension of the nanoparticles in the nanocoolant fluid, the first type of nanoparticles is hydrophobic and is paired with hydrophilic nanoparticles (the second type of nanoparticles). The stability added by the second type of nanoparticles allows for the use of a smaller amount of surfactant.

In one form, the hybrid nanoparticles are between 0.01 and 0.5 volumetric percent of the nanocoolant fluid. In one variation, the nanoparticles are between 0.1 and 0.2 volumetric percent. In yet another form, the volumetric ratio between the first type of nanoparticles and the second type of nanoparticles is one to one (1:1).

In one variation, the first type of nanoparticles is graphene nanoplatelets. The graphene nanoplatelets have a high thermal conductivity of between about 3000 and about 5000 W/mK. As a result, a smaller amount of coolant may be used. In addition, graphene nanoplatelets are an ultra-hydrophobic material having a contact angle of at least 150 degrees. In one form of the present disclosure, the density of the graphene nanoplatelets is about 2.2 g/cm³, lower than most metallic nanoparticles, which provides weight savings. In another form, the graphene nanoplatelets have a high specific surface area-up to about 2630 cm²/g, which facilitates a reactive interface between the first type and the second type of nanoparticles. In yet another form, the specific heat capacity of the graphene nanoplatelets is greater than about 790 J/kg-K, which increases the thermal capacitance of the nanocoolant. A higher thermal capacitance results in greater coolant efficiency.

The second type of nanoparticles is hydrophilic as a result of oxygen groups in the molecular structure, allowing the nanoparticles to be wetted with water. The presence of oxygen allows for covalent, ionic, and hydrogen interactions, making the dispersion more stable in an aqueous solution. In one form, the second type of nanoparticles is graphene oxide. In another form, the second type of nanoparticles is cellulose nanocrystals. Cellulose nanocrystals and graphene oxide are comparably hydrophilic. In addition, the cellulose nanocrystals have a lower density of about 1.6 g/cm³ with a higher volume-surface area ratio of between 2 and 150 m²/g.

Advantageously, none of the nanoparticles require any functionalization steps to modify the surface chemistry. As a result, the manufacture of the particles is simpler and more efficient.

The surfactant decreases the surface tension of the nanocoolant fluid and further stabilizes the dispersion of the hybrid nanoparticles. In one form, the surfactant content is between 0.05 and 0.35 volumetric percent of the nanocoolant fluid. In one of these forms, the surfactant content is between 0.15 and 0.25 volumetric percent. In one form, the surfactant is sodium dodecylbenzene sulfonate (SDBS). SDBS interacts with polar and non-polar molecules and has an aromatic group which provides a good interaction with graphene in the nanoparticles. In addition, SDBS has a higher thermal conductivity and lower viscosity compared to common alternatives, such as gum arabic or sodium dodecyl sulfate.

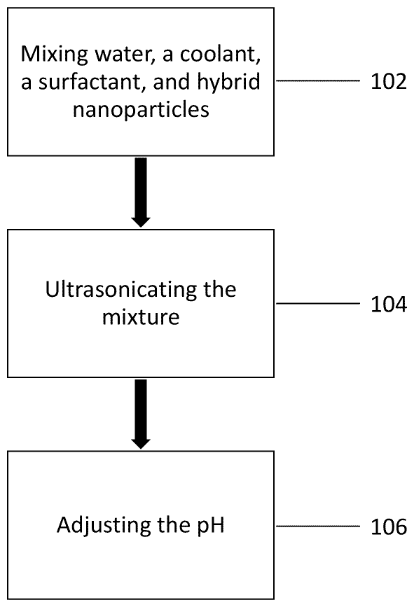

A method for producing the nanocoolant fluid is shown in FIG. 1. The components of the nanocoolant fluid, namely, water, ethylene glycol, surfactant, and nanoparticles are stirred together in a step 102. In one form, the water and ethylene glycol are mixed together first, the surfactant stirred in next, and then the nanoparticles stirred into the combination. After stirring the components together, ultrasonification is performed on the fluid in a step 104. During ultrasonification, the fluid is agitated by sound waves in ultrasonic frequencies above 20 kHz. The sonification disperses the nanoparticles, disrupts agglomeration, and homogenizes the nanofluid. In some forms, the fluid may be sonicated for 30 minutes. Any form of sonication may be used, including bath sonication or probe sonication Further, the pH of the fluid is adjusted in a step 106. In some forms, the pH is adjusted by adding an acid or base as needed. In one of these forms, the acid is phosphoric acid, which also acts as a corrosion inhibitor. The base is sodium hydroxide, which dissociates well in water. In one form, the pH is adjusted to be between 7.5 and 9. This pH level is compatible with existing vehicle cooling systems and their components.

Compared to typical coolant fluids without the nanoparticles, the thermal conductivity of the innovative nanocoolant fluid disclosed herein is up to 20% higher. As a result, the thermal efficiency of a cooling system using the nanocoolant fluid may be increased by 20%. Greater thermal efficiency may in turn allow for a smaller cooling system, thereby providing plethora of benefits to a variety of motor vehicles, among other applications.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A nanocoolant fluid comprising:
water;
a coolant;
a surfactant; and
hybrid nanoparticles, the hybrid nanoparticles comprising a first type of nanoparticles and a second type of nanoparticles, the first type of nanoparticles being thermally conductive and hydrophobic, and the second type of nanoparticles being hydrophilic.

2. The nanocoolant fluid of claim 1, wherein the first type of nanoparticles comprises graphene nanoplatelets.

3. The nanocoolant fluid of claim 1, wherein the second type of nanoparticles comprises graphene oxide nanoparticles.

4. The nanocoolant fluid of claim 1, wherein the second type of nanoparticles comprises cellulose nanocrystals.

5. The nanocoolant fluid of claim 1, wherein a volumetric ratio of the first type of nanoparticles to the second type of nanoparticles is 1:1.

6. The nanocoolant fluid of claim 1, wherein a volumetric percent of the hybrid nanoparticles is between 0.01% and 0.5%.

7. The nanocoolant fluid of claim 1, wherein the coolant is ethylene glycol and a volumetric ratio of coolant to water is 40:60 or less.

8. The nanocoolant fluid of claim 1, wherein the surfactant is sodium dodecylbenzene sulfonate and the volumetric percent of the surfactant is between 0.05% and 0.35%.

9. A nanocoolant fluid comprising:
water;
ethylene glycol;
a surfactant; and
hybrid nanoparticles, the hybrid nanoparticles comprising a first type of nanoparticles and a second type of nanoparticles, the first type of nanoparticles comprising graphene nanoplatelets, the second type of nanoparticles selected from the group comprising graphene oxide nanoparticles and cellulose nanocrystals.

10. The nanocoolant fluid of claim 9, wherein a volumetric ratio of the first type of nanoparticles and the second type of nanoparticles is 1:1.

11. The nanocoolant fluid of claim 9, wherein a volumetric percent of the hybrid nanoparticles is between 0.01% and 0.5%.

12. The nanocoolant fluid of claim 9, wherein a volumetric ratio of ethylene glycol to water is 40:60 or less.

13. The nanocoolant fluid of claim 9, wherein the surfactant is sodium dodecylbenzene sulfonate and a volumetric percent of the surfactant is between 0.05% and 0.35%.

14. A nanocoolant fluid comprising:
deionized water;
ethylene glycol;
sodium dodecylbenzene sulfonate; and
hybrid nanoparticles, the hybrid nanoparticles comprising a first type of nanoparticles and a second type of nanoparticles, the first type of nanoparticles comprising graphene nanoplatelets, and the second type of nanoparticles being hydrophilic.

15. The nanocoolant fluid of claim 14, wherein the second type of nanoparticles comprises graphene oxide nanoparticles.

16. The nanocoolant fluid of claim 14, wherein the second type of nanoparticles comprises cellulose nanocrystals.

17. The nanocoolant fluid of claim 14, wherein a volumetric ratio of the first type of nanoparticles to the second type of nanoparticles is 1:1.

18. The nanocoolant fluid of claim 14, wherein a volumetric percent of the hybrid nanoparticles is between 0.01% and 0.5%.

19. The nanocoolant fluid of claim 14, wherein a volumetric percent of the sodium dodecylbenzene sulfonate is between 0.05% and 0.35%.

20. The nanocoolant fluid of claim 14, wherein a volumetric ratio of the ethylene glycol to water is 40:60 or less.
